(19) United States
(12) Patent Application Publication
(10) Pub. No.: US 2013/0039251 A1
(43) Pub. Date: Feb. 14, 2013

(54) PROVIDING BROADCAST-UNICAST COMMUNICATION HANDOVER

(71) Applicants: Timothy Wilkinson, Bristol (GB); Jonathan Eskins, Wiltshire (GB); Neil Edgar, Wiltshire (GB); Alan Jones, Wiltshire (GB)

(72) Inventors: Timothy Wilkinson, Bristol (GB); Jonathan Eskins, Wiltshire (GB); Neil Edgar, Wiltshire (GB); Alan Jones, Wiltshire (GB)

(73) Assignee: INTELLECTUAL VENTURES HOLDING 81 LLC, Las Vegas, NV (US)

(21) Appl. No.: 13/581,252

(22) PCT Filed: Feb. 9, 2011
(86) PCT No.: PCT/EP2011/051860

§ 371 Date: Oct. 16, 2012

(30) Foreign Application Priority Data
Feb. 24, 2010 (GB) 1003111.0

(51) Int. Cl. H04W 36/14; H04W 4/06

(52) U.S. Cl. 370/312

(57) ABSTRACT

A method of delivering data to a wireless communication unit in a communication system that comprises a broadcast network and a unicast network comprises at a network element, encoding a data packet stream at a first rate for delivery over the broadcast network; encoding the same data packet stream at the first rate for delivery over the unicast network; and concurrently transmitting the encoded data packet stream over the unicast network and broadcasting the encoded data packet stream over the broadcast network.

### CROSS REFERENCE TO RELATED APPLICATIONS

This application is a 35 U.S.C. 371 application of PCT application PCT/EP2011/051860 filed Feb. 9, 2011, which claims the benefit of Great Britain application no. 1003111.0 filed Feb. 24, 2010, the contents of which are hereby incorporated by reference herein.

### FIELD OF THE INVENTION

The invention relates to utilisation of communication resources in cellular communication systems and in particular, but not exclusively, to supporting handover between broadcast communication and unicast communication in a 3rd Generation Partnership Project (3GPP) cellular communication system.

### BACKGROUND OF THE INVENTION

3rd generation cellular communication systems have been rolled out in most developed countries, further enhancing the communication services provided to mobile phone users. The most widely adopted 3rd generation communication systems are based on Code Division Multiple Access (CDMA) and Frequency Division Duplex (FDD) or Time Division Duplex (TDD) technology. In CDMA systems, user separation is obtained by allocating different spreading and/or scrambling codes to different users on the same carrier frequency and in the same time intervals. This is in contrast to time division multiple access (TDMA) systems, where user separation is achieved by assigning different time slots to different users. In addition, TDD provides for the same carrier frequency to be used for both uplink transmissions, i.e. transmissions from the mobile wireless communication unit (often referred to as wireless subscriber communication unit or user equipment (UE)) to the communication infrastructure via a wireless serving base station (often referred to as a Node B) and downlink transmissions, i.e. transmissions from the communication infrastructure to the mobile wireless communication unit via the wireless serving base station. In TDD, the carrier frequency is subdivided in the time domain into a series of timeslots. The single carrier frequency is assigned to uplink transmissions during some timeslots and to downlink transmissions during other timeslots. An example of a communication system using this principle is the Universal Mobile Telecommunication System (UMTS). Further description of CDMA, and specifically of the Wideband CDMA (WCDMA) mode of UMTS, can be found in WCDMA for UMTS, Harri Holma (editor), Antti Toskala (Editor), Wiley and Sons, 2001, ISBN 0471486876.

In order to provide enhanced communication services, the 3rd generation cellular communication systems are designed to support a variety of different and enhanced services. One such enhanced service is multimedia services. The demand for multimedia services that can be received via mobile phones and other hand held devices is set to grow rapidly over the next few years. Multimedia services, due to the nature of the data content that is to be communicated, require a high bandwidth. As radio spectrum is at a premium, spectrally efficient transmission techniques are required in order to provide users with as many broadcast services as possible, thereby providing mobile phone users (subscribers) with the widest choice of services. It is known that broadcast services may be carried over cellular networks, in a similar manner to conventional terrestrial Television/Radio transmissions. The typical and most cost-effective approach in the provision of multimedia services is to broadcast’ the multimedia signals, as opposed to sending the multimedia signals in an unicast (i.e. point-to-point) manner. Typically, this allows tens of channels carrying say, news, movies, sports, etc. to be broadcast simultaneously over a communication network.

Technologies for delivering multimedia broadcast services over cellular systems, such as the Release 6 Mobile Broadcast and Multicast Service (MBMS) for UMTS, have been developed over the past few years. In these broadcast cellular systems, the same broadcast signal is transmitted over non-overlapping physical resources (timeslots and carrier frequencies) on adjacent cells within a conventional cellular system. Broadcast networks are likely to be deployed as an overlay to existing unicast networks. However, the broadcast networks are likely to be provided with a subset of the coverage of a given unicast network. For economic reasons broadcast networks will be deployed first where there is an identified heavy usage of video and audio streaming services on the unicast networks, for example in typically more populated metropolitan areas, in order to alleviate the traffic load. Outside of these areas, in less populated rural areas, broadcast networks may be required later, or indeed never, because there continues to be sufficient spare capacity on the unicast networks for these services. Thus, it will be essential to be able to handover the video and audio services between broadcast and unicast networks in a seamless (or substantially seamless) manner when a user is moving between these different types of areas.

It is likely that handover of communication between broadcast and unicast networks will be triggered based on measurements of signal strength and quality on the two networks. Typically, in a case where the broadcast coverage is a subset of the unicast coverage, this may be achieved based on measurements made only on the broadcast network; the assumption being that the broadcast network is the preferred network for delivering data assuming that it is available.

However, the process of handover is recognized as being lossy with respect to data packets, as often the coverage from one network will be lost before the connection with the other can be established. Thus, the delivery of data packets may be affected, inasmuch as data packets may be lost whilst the handover process is being performed. It is known that error detection and correction mechanisms are used in wireless communication networks to hopefully correct for any detected data packet losses. However, errors are managed in very different ways in broadcast and unicast networks.

In broadcast networks, where traffic is sent to many users, the only possible error recovery mechanism is forward error correction (FEC). However, FEC is known to be very inefficient if the errors bursts are infrequent and ineffective when the bursts are too long, both of which are characteristics of error bursts during a handover process. Additionally, FEC also adds latency depending on the protection period employed.

In unicast networks, where the traffic is sent to one user, either FEC or automatic repeat request (ARQ) techniques may be used. Occasionally, both FEC and ARQ may be employed, where a certain amount of FEC is applied to reduce a number of re-transmissions required through employing ARQ. FEC is known to be very good at recovering randomly distributed errors, whereas ARQ is known to be very good at recovering large bursts of errors. FEC is also preferred when jitter is not acceptable. ARQ is known to be more efficient when the error bursts are infrequent. ARQ will not work at all on broadcast networks because the errors that occur, and the recovery of these, is unique to a particular user but the broadcast signal is sent to all users. The only workable method for error recovery on broadcast is FEC. However, this is less efficient for the type of errors on handover because they are, by their very nature, bursty.

Thus, a complete recovery of lost (errored) packets on handover between broadcast and unicast delivery networks is less than ideal, as the most appropriate technique to be employed for either delivery mechanism fails to work in an acceptable manner, or even at all, on the other delivery network. Thus, whichever error detection and correction approach is selected for one delivery network creates errors during both handover to the other delivery network as well as when subsequently delivering data packets on the other delivery network.

Consequently, current error correction techniques for handover between broadcast and unicast systems are suboptimal. Hence, an improved mechanism to address the problem of supporting handover between a broadcast network and a unicast network in a cellular network would be advantageous. In particular, a system allowing for the provision of a substantially loss-free handover between broadcast and unicast transmissions would be advantageous.

### SUMMARY OF THE INVENTION

Accordingly, the invention seeks to mitigate, alleviate or eliminate one or more of the abovementioned disadvantages singly or in any combination.

According to a first aspect of the invention, there is provided a method of delivering data to a wireless communication unit in a communication system that comprises a broadcast network and a unicast network. The method comprises, at a network element, encoding a data packet stream at a first rate for delivery over the broadcast network; encoding the same data packet stream at the first rate for delivery over the unicast network; and concurrently transmitting the encoded data packet stream over the unicast network and broadcasting the encoded data packet stream over the broadcast network.

In this manner, examples of the invention may allow improved use of the communication resource in the communication system, for example by reducing a number of lost packets due to handover, and/or reduce a number of automatic repeat request transmissions to replace lost data packets. Examples of the invention may allow improved performance as perceived by the end-users, for example by provision of a smoother data stream, for example of multimedia content. Examples of the invention may be compatible with some existing communication systems, such as 3GPP WCDMA, time division (TD)-CDMA or TD-SCDMA cellular communication systems, used in conjunction with 3GPP and non 3GPP broadcast technologies, such as digital video broadcast for handsets (DVB-H), its evolution Next Generation Handheld (NGH), Flo, and digital video broadcast for satellite-based handsets (DVB-SH).

According to an optional feature, the method may further comprise incorporating a delay into the encoded data packet stream for delivery over the broadcast network, such that there is a packet number offset in the concurrent transmitting of the encoded data packet stream over the unicast network and the broadcasted encoded data packet stream over the broadcast network. Thus, incorporating a delay into the encoded data packet stream for delivery over the broadcast network may allow a smooth transition of the data stream to be encoded at a wireless communication unit, as reception and decoding of the data packets of the delayed broadcast network may align with the reception and decoding of the data packets of the non-delayed unicast network, with any lost data packets due to performing a handover process having being accounted for by the advance nature of the unicast data delivery.

According to an optional feature of the invention, the method may be performed by a streaming server and may further comprise performing handover of communication to the wireless communication unit between the unicast network and the broadcast network.

According to a second aspect of the invention, there is provided for performing handover in a communication system that comprises a broadcast network and a unicast network. The method comprises, at a wireless communication unit, decoding a data packet stream at a first rate delivered over a first network; performing a handover from the first network to a second network and decoding the same data packet stream at the first rate over the second network. The first network and the second network operate different delivery mechanisms and comprise either a unicast network or a broadcast network.

According to an optional feature of the invention, the same data packet stream broadcast over the broadcast network may be delayed from the unicast transmission of the same data packet stream. Thus, a delay in the same data packet stream delivered over the broadcast network may allow a smooth transition of the data stream to be encoded at the wireless communication unit, as reception and decoding of the data packets of the delayed broadcast network may align with a reception and decoding of the data packets of the non-delayed unicast network, with any lost data packets due to performing a handover process having being accounted for by the advance nature of the unicast data delivery.

According to an optional feature of the invention, following a handover from a unicast network to a broadcast network, the delay between reception of the same data packet stream over the broadcast network may allow the first data packet received on the broadcast network to be inserted into the data stream for decoding without loss of any data packets. According to an optional feature of the invention, the method may further comprise buffering data packets received over the unicast network.

According to an optional feature of the invention, the method may further comprise inserting the buffered additional data packets in the data packet stream to replace data packets that have already been lost in a handover to the broadcast network; and/or storing the received additional data packets in advance of a loss of future data packets through a handover process for subsequent insertion in the data packet stream.

According to a third aspect of the invention, there is provided a network element for delivering data to a wireless communication unit in a communication system that comprises a broadcast network and a unicast network. The network element comprises at least one encoder arranged to encode a data packet stream at a first rate for delivery over the broadcast network and encode the same data packet stream at the first rate for delivery over the unicast network; and a transmitter arranged to concurrently transmit the encoded data packet stream over both the unicast network and the broadcast network.

According to a fourth aspect of the invention, there is provided a wireless communication unit for performing handover in a communication system that comprises a broadcast network and a unicast network. The wireless communication unit comprises a receiver arranged to receive a data packet stream at a first rate delivered over a first network; a decoder arranged to decode the received data packet stream; a signal processor arranged to perform a handover from the first network to a second network. Following handover, the decoder is arranged to decode the same data packet stream at the first rate over the second network. The first network and the second network are arranged to operate different delivery mechanisms and comprise a unicast network and a broadcast network.

According to a fifth aspect of the invention, there is provided an integrated circuit for a network element to deliver data to a wireless communication unit in a communication system that comprises a broadcast network and a unicast network, the integrated circuit comprising: at least one encoder arranged to encode a data packet stream at a first rate for delivery over the broadcast network and encode the same data packet stream at the first rate for delivery over the unicast network; and a transmitter arranged to concurrently transmit the encoded data packet stream over both the unicast network and the broadcast network.

According to a sixth aspect of the invention, there is provided an integrated circuit for a wireless communication unit to perform handover in a communication system that comprises a broadcast network and a unicast network. The integrated circuit comprises a receiver arranged to receive a data packet stream at a first rate delivered over a first network; a decoder arranged to decode the received data packet stream; and a signal processor arranged to perform a handover from the first network to a second network. Following handover, the decoder is arranged to decode the same data packet stream at the first rate over the second network. The first network and the second network operate different delivery mechanisms and each comprise one of: a unicast network and a broadcast network.

According to a seventh and an eighth aspect of the invention, there is provided a tangible computer program product having executable program code substantially in accordance with the first or second aspects of the invention.

These and other aspects, features and advantages of the invention will be apparent from, and elucidated with reference to, the embodiment(s) described hereinafter.

### BRIEF DESCRIPTION OF THE DRAWINGS

Embodiments of the invention will be described, by way of example only, with reference to the accompanying drawings, in which

FIG. 1 illustrates an example of a 3GPP cellular communication architecture comprising broadcast and unicast networks and adapted in accordance with embodiments of the invention.

FIG. 2 illustrates a further example of a communication architecture comprising broadcast and unicast networks and adapted in accordance with embodiments of the invention.

FIG. 3 illustrates an example of a wireless communication unit adapted in accordance with some embodiments of the invention.

FIG. 4 illustrates an example of a timing diagram that shows a handover between broadcast and unicast communication frames in accordance with some embodiments of the invention.

FIG. 5 illustrates an example of a method for handover from a broadcast network to a unicast network in accordance with some embodiments of the invention.

FIG. 6 illustrates an example of a method for handover from a unicast network to a broadcast network in accordance with some embodiments of the invention.

FIG. 7 illustrates a typical computing system that may be employed to implement signal processing functionality in embodiments of the invention.

### DETAILED DESCRIPTION

The following description focuses on example embodiments of the invention applicable to a UMTS (Universal Mobile Telecommunication System) cellular communication system and in particular to a UMTS Terrestrial Radio Access Network (UTRAN) operating in a Time Division Duplex (TDD) mode within a 3rd generation partnership project (3GPP) system. However, it will be appreciated that the invention is not limited to this particular cellular communication system, but may be applied to other cellular communication systems. The following description also focuses on example embodiments of the invention applicable to a system that supports both a broadcast network and a unicast network.

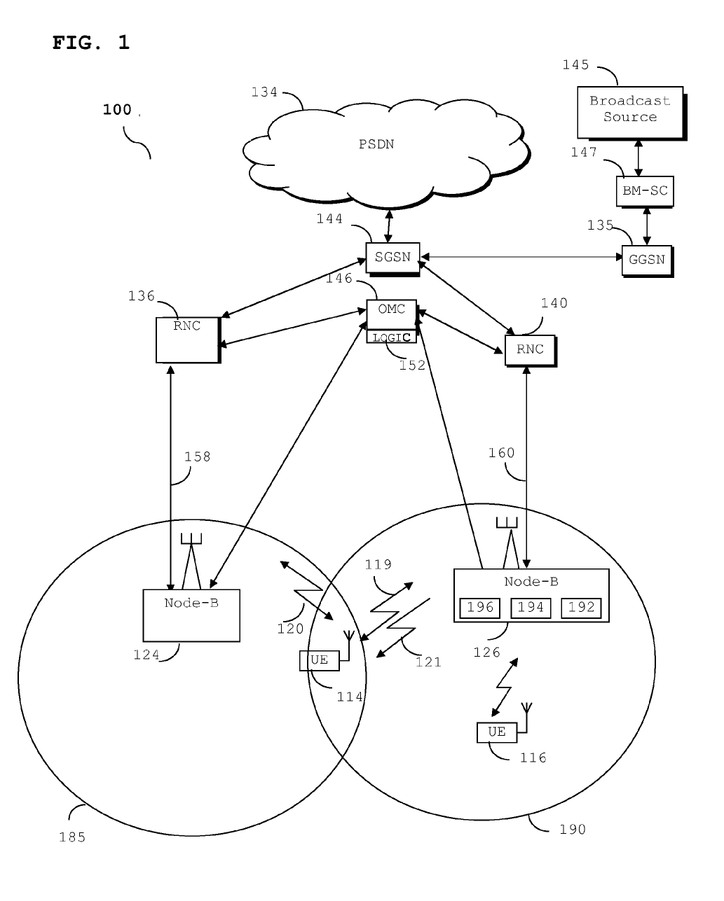

Referring now to FIG. 1, a cellular-based communication system 100 is shown in outline, in accordance with an example embodiment of the invention. In this example embodiment, the cellular-based communication system 100 is compliant with, and contains network elements capable of operating over, an universal mobile telecommunication system (UMTS) air-interface. In particular, the example embodiment relates to the Third Generation Partnership Project (3GPP) specification for wide-band code-division multiple access (WCDMA), time-division code-division multiple access (TD-CDMA) and time-division synchronous code-division multiple access (TD-SCDMA) standard relating to the UTRAN radio interface (described in the 3GPP TS 25.xxx series of specifications). In particular, the example embodiment of the 3GPP system is adapted to support both broadcast and unicast UTRA communication in one or more communication cells.

In a unicast mode of operation, a plurality of wireless subscriber communication units/terminals (or user equipment (UE) in UMTS nomenclature) 114, 116 communicate, for example in a bi-directional manner, over radio links 119, 120 with a plurality of base transceiver stations, referred to under UMTS terminology as Node-Bs, 124, 126. The cellular communication system comprises many other UEs and Node-Bs, which for clarity purposes are not shown. The cellular communication system, sometimes referred to as a Network Operators Network Domain, is connected to an external network, for example the Internet. The Network Operators Network Domain includes: (i) A core network, namely at least one Gateway General Packet Radio System (GPRS) Support Node (GGSN) 135 and at least one Serving GPRS Support Nodes (SGSN) 144; and (ii) An access network. The access network comprises: a plurality of UMTS Radio network controllers (RNCs) 136, 140; operably coupled to a plurality of UMTS Node-Bs 124, 126. The GGSN 135 or SGSN 144 is responsible for UMTS interfacing with a Public network, for example a Public Switched Data Network (PSDN) (such as the Internet) 134 or a Public Switched Telephone Network (PSTN). The SGSN 144 performs a routing and tunnelling function for traffic, whilst a GGSN 135 links to external packet networks. The Node-Bs 124, 126 are connected to external networks, through RNCs 136, 140 and mobile switching centres (MSC5), such as SGSN 144. A cellular communication system will typically have a large number of such infrastructure elements where, for clarity purposes, only a limited number are shown in FIG. 1. Each Node-B 124, 126 contains one or more wireless transceiver units and communicates with the rest of the cell-based system infrastructure via an Lb interface, as defined in the UMTS specification.

Each RNC 136, 140 may control one or more Node-Bs 124, 126. In the illustrated example, Node-B 124 supports both broadcast (e.g. uni-directional) and unicast (e.g. bi-directional) communication over geographic area 185 and Node-B 126 supports communication over geographic area 190. As illustrated, Node-B 126 comprises a transmitter 194 that is operably coupled to a signal processor module 196 and a timer 192. Embodiments of the invention utilize the signal processor module 196 and timer 192 to configure data packet transmissions from the Node-B 126 in both a broadcast mode of operation and a unicast mode of operation. In supporting 1 MB, the signal processor module 196 is arranged to support broadcast traffic on a separate dedicated carrier frequency, which might be transmitted from the same or similar equipment as the WCDMA unicast, on the same site and connected to the same core network.

Each SGSN 144 provides a gateway to the external network 134. The Operations and Management Centre (OMC) 146 is operably connected to RNCs 136, 140 and Node-Bs 124, 126. The OMC 146 comprises processing functions (not shown) and logic functionality 152 in order to administer and manage sections of the cellular communication system 100, as is understood by those skilled in the art.

In a broadcast mode of operation, FIG. 1 illustrates a simplified example of an architecture for providing broadcast (e.g. uni-directional) services on a 3GPP network, for example a Mobile Broadcast and Multicast Service (MBMS). MBMS is a broadcasting and multicasting service offered over mobile telecommunications networks, such as General Packet Radio System (GPRS) networks, Universal Mobile Telecommunication System (UMTS) networks, Evolved Packet System (EPS), and the like. The technical specifications for MBMS include 3GPP TS 22.146, 3GPP TS 23.246 and 3GPP TS 26.346. A plurality of wireless subscriber communication units/terminals (or user equipment (UE) in UMTS nomenclature) 114, receive broadcast transmissions over radio link 121 from at least one of a plurality of base transceiver stations, illustrated only as Node-B 126 for simplicity purposes. In the broadcast mode of operation RNC 140 configures the physical resources of the individual Node B 126 for the multimedia services and provides the data to Node B 126 ready for transmission.

A single SGSN 144 can be operably coupled to a single RNC 140, or a single SGSN 144 can be operably coupled to multiple RNCs 136, 140, as shown. The SGSN 144 allocates the necessary resources within the RNCs 136, 140 that are responsible for communication within individual cells (supported by respective NodeBs 124, 126). In a broadcast mode of operation, the SGSN 144 forwards the multimedia data streams for the services to the RNC 140 and thereon to Node B 126.

The GGSN 135 may be operably coupled to one or more SGSN 144. In a broadcast mode of operation, the GGSN 135 may be operably coupled to a Broadcast Multicast Service Centre (BM-SC) 147, which in turn may be operably coupled to any network, for example a shared MBMS network comprising at least one source of broadcast media 145. In a broadcast mode of operation, the GGSN identifies the necessary paths for data to be routed to subscribing mobile stations, such as UE 114, as well as reserving the necessary resources to facilitate the broadcast delivery of data through the SGSN 144. The GGSN 135 also provides the SGSN 144 with the multimedia data for the requested service(s) as received from the BM-SC 147. The BM-SC 147 handles the announced services and allocates resources in a broadcast network, for example the MBMS network, through the GGSN 135. Multimedia data for the services provided is forwarded to the GGSN 135 as packetized data, for example using Internet Protocol (IP) multicast techniques. In this manner, services are announced by, and data for services are provided by, the broadcast media source 145 (sometimes referred to as a content provider).

In accordance with one example embodiment of the invention, the same broadcast (e.g. uni-directional) packet stream is supplied to UE 114 through a broadcast network and a unicast network, such that the packet streams on both are encoded at the same rate and the packets of the same number contain the same data. A time offset is applied, for example by timer 192, of the order of a discontinuity of a handover between the broadcast network and the unicast network, and preferably greater than the number of packets that might be lost in a handover. In one example, the time offset may be configured as being up to, say, one second. In this manner, at any time instant the unicast stream of data is ahead, or advanced in packet number, of the broadcast stream. In one example, the time offset may be implemented in the RNC 140. In one example, the time offset may be implemented as a programmable delay to the packet stream, to ensure that the broadcast stream operates behind (in a time context) the unicast transmissions of the same packet stream.

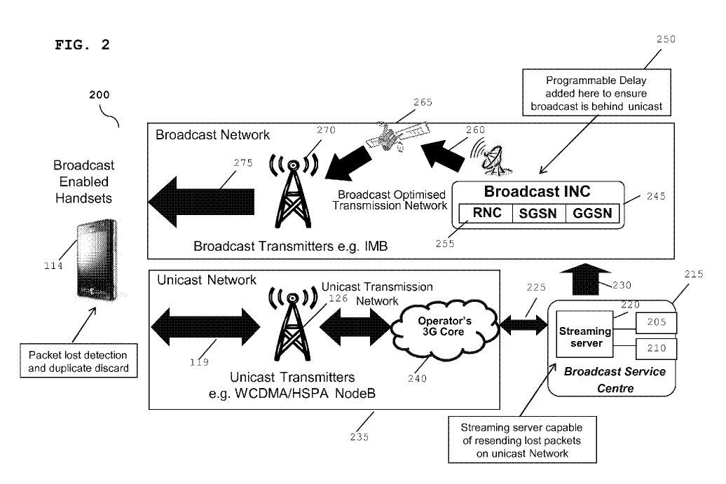

Referring now to FIG. 2, a further example of a communication architecture 200 comprising broadcast and unicast networks, adapted in accordance with an alternative example embodiment of the invention, is illustrated. The further example of a communication architecture 200 comprises a broadcast service centre 215 comprising a streaming server 220. The streaming server 220 comprises, or is operably coupled to (as shown), buffering logic 210 and a transmitter 205 arranged to re-send lost packets on a unicast network. In one example, logic to respond to ARQ requests (not shown) may be coupled to transmitter 205. The logic to respond to ARQ requests may be activated and configured to provide additional data packets to the wireless communication upon reception of an ARQ request when the UE is receiving packet data streams over the bi-directional unicast network. In this manner, in using the uplink communication channel of the unicast network to send/receive ARQ transmissions, and the downlink communication channel to send the requested additional (lost) data packets), a loss free handover between broadcast and unicast communication of the streamed data may be achieved without any additional overhead other than where it is necessary when errors have occurred.

The streaming server 220 communicates 225 with a unicast network 235, which in one example embodiment comprises a Network Operator's 3G core network 240. The Network Operator's 3G core network 240 is operably coupled to a WCDMA high speed packet access (HSPA) Node B 126, which has unicast communication 119 with UE 114.

The streaming server 220 also communicates 230 with a broadcast network 250, which in one example embodiment comprises a broadcast integrated network component (BINC) 245, comprising, in one example, functionality 255 of part or all of one or multiples of: RNC(s), a SGSN and a GGSN. For example, the BINC 245 may comprise GGSN logic, arranged, inter alia, to terminate the interface to BM-SC 215. The BINC 245 is operably coupled to at least one iMB transmitter 270, for example via a satellite 265 and associated satellite communication link 260. The at least one iMB transmitter 270 is arranged for broadcast communication 275 with UE 114. In one example, the BINC 245 comprises radio network control logic that has been divided into two distinct functional operations, namely to respectively and independently support control plane and data plane traffic. In separating the logical and functional operations in this manner, in a broadcast scenario, a more efficient use of processing resources may be achieved, with lower requirements for bandwidth in the transport network.

In accordance with one example embodiment of the invention, the same broadcast packet stream is supplied to both the broadcast network 250 and unicast network 235, such that the packet streams on both are encoded at the same rate and the packets of the same number contain the same data. A time offset is applied, for example of the order of the discontinuity of the handover between the broadcast network and the unicast network, and preferably greater than the number of packets that might be lost in a handover. In one example, the time offset may be configured as being up to, say, one second. In this manner, at any time instant the unicast stream is ahead, or advanced in packet number, of the broadcast stream. In one example, the time offset may be implemented in the Broadcast INC 245 as a programmable delay to the packet stream, to ensure that the broadcast stream operates behind (in a time context) the unicast transmissions of the same packet stream.

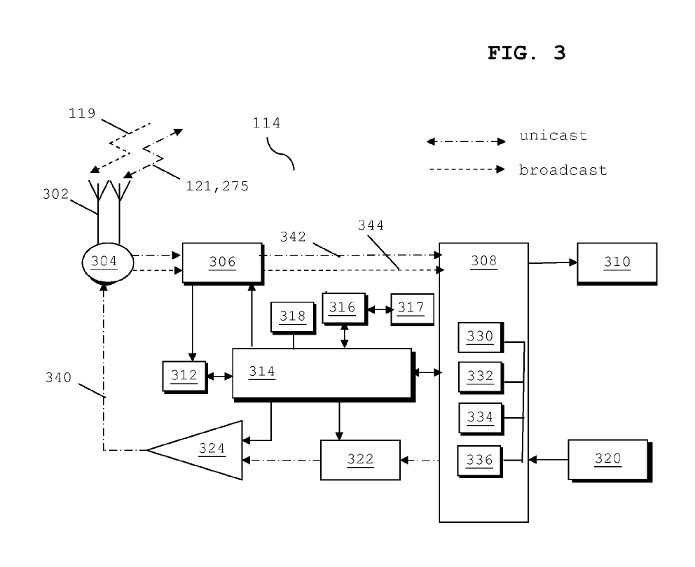

Referring now to FIG. 3, a block diagram of a wireless communication unit 114, adapted in accordance with some example embodiments of the invention, is shown. In practice, purely for the purposes of explaining embodiments of the invention, the wireless communication unit is described in terms of a user equipment (UE). The wireless communication unit 114 contains an antenna, an antenna array 302, or a plurality of antennae, coupled to antenna switch 304 that provides isolation between receive and transmit chains within the wireless communication unit 114. One or more receiver chains, as known in the art, include receiver front-end circuitry 306 (effectively providing reception, filtering and intermediate or base-band frequency conversion). The receiver front-end circuitry 306 is coupled to a signal processing module 308. An output from the signal processing module 308 is provided to a suitable output device 310, such as a screen or display. The one or more receiver chain is/are operably configured to receive 342 a data packet stream over a unicast network 121, 275 or receive 344 the same data packet stream a broadcast network 119. In one example embodiment, separate receiver chains (not shown) are used for broadcast and unicast reception. A skilled artisan will appreciate that the level of integration of using receiver circuits or components may be implementation-dependent, but may be separate up to a video decoder.

A controller 314 maintains overall operational control of the wireless communication unit 114. The controller 314 is also coupled to the receiver front-end circuitry 306 and the signal processing module 308 (generally realised by a digital signal processor (DSP)). The controller 314 is also coupled to a buffer module 317 and a memory device 316 that selectively stores operating regimes, such as decoding/encoding functions, synchronisation patterns, code sequences, and the like. A timer 318 is operably coupled to the controller 314 to control the timing of operations (transmission or reception of time-dependent signals) within the wireless communication unit 114.

As regards the transmit chain, this essentially includes an input device 320, such as a keypad, coupled in series through transmitter/modulation circuitry 322 and a power amplifier 324 to the antenna, antenna array 302, or plurality of antennae. The transmitter/modulation circuitry 322 and the power amplifier 324 are operationally responsive to the controller 314. The transmit chain is operably configured to transmit 340 an automatic re-transmission request for missing/lost data packets from the data packet stream over the bi-directional unicast network 121, 275.

The signal processor module 308 in the transmit chain may be implemented as distinct from the signal processor in the receive chain. Alternatively, a single processor may be used to implement processing of both transmit and receive signals, as shown in FIG. 3. Clearly, the various components within the wireless communication unit 114 can be realized in discrete or integrated component form, with an ultimate structure therefore being an application-specific or design selection.

In accordance with embodiments of the invention, the signal processor module 308 has been adapted to comprise logic (encompassing hardware, firmware or software) to facilitate joint error recovery for both broadcast and unicast communication of the same packet data stream. In one example, the signal processor module 308 comprises handover application logic 330 arranged to process data packets, buffer received packets in buffering logic 317 or buffering logic 332 and display data packets on display 310 from received data streams, before during and after respective handover operations between reception of the data packet streams on a unicast network and a broadcast network.

In one example, the signal processor module 308 also comprises error recovery logic 334, which may, in some examples, comprise automatic repeat request (ARQ) logic arranged to provide both error recovery mechanisms to the wireless communication unit, irrespective of whether a broadcast or uni-directional unicast communication is being used in streaming the data. In one example, ARQ logic may be activated and configured to request transmission of additional data packets when the wireless communication is receiving unicast packet data streams. In this manner, loss free handover between broadcast and unicast communication of the streamed data may be achieved without any additional overhead other than where it is necessary when errors have occurred.

In some examples, a time offset is introduced between the unicast and broadcast transmission of the same information. In addition, in some examples, error recovery logic 334, together with timer 318, is arranged to perform a fast start when the wireless communication unit is receiving unicast data streams, in order to request, obtain and buffer additional packets of the data stream. The additional data packets may be requested using the transmit chain, with the request co-ordinated by the error recovery logic 334 and/or controller 314. The additional requested data packets, once they are received over the unicast network, may be stored in buffering logic 332, and in some examples are maintained at different depths that list the stored data packet elements. Such a buffering of additional packets in a unicast mode of operation may be performed in the knowledge that some of these additional packets will be lost on handover to a broadcast network reception and subsequent return to a unicast network reception. Once the return to a unicast network reception has been made the buffers in buffering logic 332 may be replenished.

In one example, the level of buffering performed at the receiver, in a broadcast mode of operation, may be the typical amount to smooth a playback of the data stream, which is technology dependent. However, in a unicast mode of operation, in some examples, the level of buffering performed at the receiver may be arranged to be at least the typical amount to smooth a playback of the data stream plus twice the typical number of packets that may be lost during a handover operation. In this manner, there is a sufficient number of extra’ packets in the buffer to substitute for those that may or will be lost on handover, in either direction, until this buffer can be replenished. Thus, if the level of buffering is not fully maintained with the maximum or desired number of buffered data packets, then error recovery logic 334 may be arranged to identify a number of additional data packets to be retrieved to maintain the buffer. In a non-optimised system this level of buffering may be, say, up to 27 packets or approximately one second in duration.

When handing over reception from a broadcast network to a unicast network, the signal processor module 308 may also comprise packet discard logic 336 arranged to identify duplicate packets that are received via the unicast network to those already maintained in the buffering logic 332 and received over the pre-handover broadcast network. Thereafter, the packet discard logic 336 may be arranged to discard those duplicate packets that have also subsequently been received over the unicast network after performing the handover.

In one example embodiment, the UE may be able to re-configure the buffering depth that is being used, either in response to a trigger, such as based on the type of data being received, or may be programmable.

In one example embodiment, the handover application logic 330 may be arranged to switch its decoding operation to the video stream received from the (new) handed over network only after the receiving the first Real-time Transport Protocol (RTP) data packet on the new packet stream, in order to minimise handover induced losses.

Thus, in some examples, extra redundancy may be provided either only once at switch over of the decoding operation or on each return to reception over the unicast network. In this sense, the proposed mechanism is particularly efficient, as this extra redundancy is only invoked when needed. In comparison, a forward error correction (FEC) scheme to provide the same level of protection would require substantially increased redundancy, and require this redundancy to always be in place, even when a handover between services causing errors might occur infrequently.

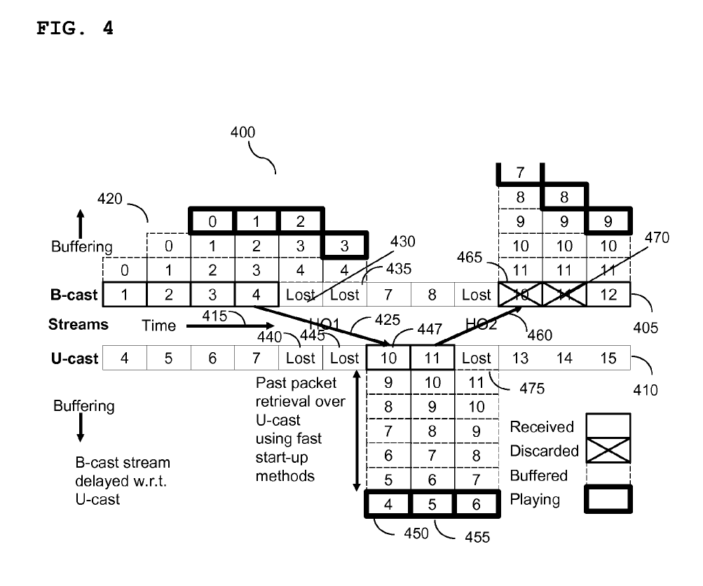

Referring now to FIG. 4, an example of a timing diagram 400 is illustrated that shows a time frame 415 of a handover process between broadcast data packet frames 405 and unicast data packet frames 410, in accordance with some example embodiments of the invention. As illustrated with respect to the frame numbers, the broadcast network buffers 420 data packets to be broadcast, such that the broadcast data stream is delayed by three frames from the same data stream that is transmitted over the unicast network. Just before a first handover 425 the UE receiver is receiving the broadcast stream and is, in particular, receiving packet no #4, but is playing/displaying packet number #1, due to the buffering depth that is being used. The trigger for the first handover 425 occurs, for example as stipulated by either the broadcast network or unicast network in response to signal level measurements, and the UE receiver switches from broadcast to unicast reception, which takes at least a packet duration. Thus, one or more data packet(s), namely packet number #5 430 and packet numbers #6 435 on the unicast communication (equivalent packet number #8 440 and packet numbers #9 445 on the broadcast communication) are lost. In addition, due to the time delay employed in the broadcast data stream, three further data packets that have already been sent over the unicast network, namely packet numbers #5-#7, have not been received by the UE.

Just after the first handover 425 occurs the UE receiver receives the packet stream from the unicast network and is receiving packet no. #10 447 from the unicast stream and playing packet no. #4. However, the UE is able to determine that it has not received any packets between packet no. #4 received from the broadcast network and packet no. #10 received from the unicast network. In response to this determination the UE is able to request packet numbers #5 -#9 to be delivered over the unicast network using a past packet retrieval process using a fast data packet catch-up method.

The UE buffers the received additional packets, based on a reference position of the new stream. These new requested data packets are the same as the packets just lost on the handover transition and, in some examples may include further data packets to compensate for the buffering depth employed, may thus mitigate those losses. Additionally, this process also provides a buffer of packets to compensate for any that may be lost on the transition back to receiving the packet stream from the broadcast network, e.g. the second handover illustrated 460. This past-packet retrieval approach is only possible on the unicast network as additional resource can be allocated to this particular user for this purpose. For example, the unicast network may transmit the packets to be buffered on multiple slots or use more resource in any given dimension, e.g. slots, codes, etc. in order to deliver the requested packets to the UE. Alternatively, the unicast network may transmit at a higher rate on the same amount of resource, for example should the user be located in an advantageous location in the communication cell.

Although the example illustrated in FIG. 4 shows an immediate second handover 460 following a first handover 425, it will be appreciated that such a simplified timing structure is illustrated for simplicity purposes only, and other timing gaps between the respective handovers may be employed, using the examples described.

Just before the second handover 460 is performed, in the illustrated example, the receiver is receiving the packet stream on the unicast network and is notably receiving packet number #11. However, the communication unit is illustrated as playing packet number #5 455, due to the buffering depth. Following a trigger for the second handover 460 occurring, the receiver switches from receiving on the unicast network to receiving on the broadcast network, which takes at least a packet duration and, thus, a packet or more (at least packet number #12 475) is lost. Just after the second handover 460, the receiver is receiving on the broadcast network and is receiving packet number #10 465 from the broadcast stream. At this time, the communication unit is playing packet number #7, but identifies that it already has packet #10 447 in its buffers from the unicast transmission. Therefore, the communication unit discards the received packet number #10 465 received from the broadcast network. The same scenario of receiving, identifying and discarding packet number #11 470 also occurs, before the receiver receives packet number #12 on the broadcast network and continues. From this point onwards the process continues with packets received over the broadcast network being placed in the buffer and the buffer size being maintained.

One specific scenario has been described in FIG. 4 in terms of the dimensions of the losses, stream delays and buffer sizes, etc. However, in other examples, the stream delays and buffer sizes may be dimensioned to accommodate any potential packet losses during a handover process.

As can be seen from the process described above, despite the fact that there is a finite time in handover in either direction, where packets cannot be received and are potentially lost, the examples described make it possible to receive and ultimately play every packet in the packet stream throughout the handover process. Moreover, it is envisaged that the handover process described herein may be applied to any scenario where there is handover between broadcast networks and unicast networks, either in a wired or wireless scenario.

Thus, a provision of true seamless broadcast-unicast handover may be provided by the introduction of a delay between the delivery of the same packet stream over both a unicast network and a broadcast network. In addition, the herein described mechanism further incorporates an opportunity to force a request for additional past packet transmission on the unicast network, as well as a provision of buffering of requested additional packets. This, in effect in one aspect, may be considered as containing some similarities to standard ARQ processes by replacing the data packets that have been lost through a broadcast to unicast handover. Advantageously, this additional packet request mechanism on the unicast network may also be extended to encompass, and thereby negate, potential future packets that will be lost in future handover processes, in the other direction, i.e. unicast network to broadcast network handover, by the provision of packet buffering. Thus, additional packets requested can advantageously exceed those that are actually lost, as the surplus packets can be readily discarded.

Furthermore, the use of a fast start data packet retrieval mechanism over the unicast network allows both data packets after a loss and a potential number of data packets to be lost in the future to be acquired. Thus, the fast start data packet retrieval mechanism over the unicast network allows lost data packets due to the handover to be recovered, as well as provisioning of additional packets to compensate for a time offset between the delivery of the same data packets between the unicast network and the broadcast network when performing a further handover between networks.

In one example embodiment, the UE may be configured to extract from a received broadcast portion of the data packet stream information that relates to a unicast bearer. The UE may then be configured to use the extracted information to establish a unicast bearer. In this manner, a unicast bearer may be established when coverage on the broadcast network is lost.

In one example embodiment, a UE may be configured to support two modes of operation, a first broadcast mode of operation, and a second unicast mode of operation. The first broadcast mode of operation may support an idle state procedure, and the second unicast mode of operation may support both an idle state procedure and a connected state procedure. When the UE is operating in the first broadcast mode of operation, the signal processing module 308 of FIG. 3 may comprise detection logic (not shown) arranged to determine when broadcast network coverage is lost. In response to such a determination that the broadcast network coverage is lost, the detection logic of the UE may be configured to send a signal to unicast switching logic (not shown), which may form a part of signal processing module 308 of FIG. 3. The signal that is sent to unicast switching logic may be configured to switch the UE unicast operation from an idle state to a connected state, upon determination that the broadcast network coverage is lost.

It is envisaged that, in some scenarios, a UE may not be in broadcast coverage but may be in unicast coverage. Thus, in a further example embodiment, the first broadcast mode of operation would be in an idle state and may be taking measurements of signal strength, or some other metric, for determining the availability of a broadcast network. In this further example embodiment, the second unicast mode of operation would be in a connected state and may be receiving data packets from the unicast network. When the UE moves into coverage from the broadcast network, an indication of broadcast network availability may be made available to detection logic. In response to such an indication the first broadcast mode of operation would remain in an idle state and start receiving data packets. The second unicast mode of operation may release its unicast connection and move from a connected state to an idle state. It will be understood that maintaining the first broadcast mode of operation in an idle state advantageously reduces the time it takes to handover from a unicast mode to a broadcast mode. The result of a reduced handover time enables unicast resources to be assigned much sooner to other UEs.

In a yet further example embodiment, an availability of a broadcast network may be signalled to the UE when the UE is receiving the data packet stream via the second unicast mode of operation. For example, in one example embodiment, the unicast network may transmit the availability of broadcast carriers, on the unicast carrier. This availability of broadcast carrier information may be transmitted on the broadcast channel (BCH) of the unicast carrier, for example. The BCH can be read in both idle and connected state. In an alternative embodiment, an availability of broadcast carriers may be transmitted to the UE via dedicated signalling in connected mode. A skilled artisan will appreciate that other mechanisms for transmitting an availability of broadcast carriers to the UE may be employed. In response to the information, the first broadcast mode of operation would remain in an idle state, and may use the information to aid and accelerate the process of taking measurements for determining the availability of a broadcast network.

In a still yet further example embodiment, the first broadcast mode of operation of the UE may be in a low power state and may not be taking measurements of broadcast network availability. In this still yet further example embodiment, the UE operating in a low power state of the first broadcast mode of operation may be informed by the second unicast mode of operation of the availability of a broadcast network. The second unicast mode of operation may be in an idle state or connected state when providing such information. In response to the information, the UE wakes up logic associated with running its first broadcast mode of operation, and thus may move from a low power state to a normal operating power state of the first broadcast mode of operation, but would remain in an idle state. In the first broadcast mode of operation, the UE may perform one or more broadcast coverage measurements, after which time the UE returns to sleep or starts decoding the broadcast signal. The advantage of such a process is the broadcast mode of operation is able to stay in an idle state and conserve battery power by using information provided by the second unicast mode of operation. In this manner, the broadcast mode of operation may transition into a power saving mode when not being used. In one example embodiment, the availability of the broadcast carrier is signalled in BCH on unicast. In an alternative embodiment, an availability of broadcast carriers may be transmitted to the UE via dedicated signalling in connected mode. A skilled artisan will appreciate that other mechanisms for transmitting an availability of broadcast carriers to the UE may be employed.

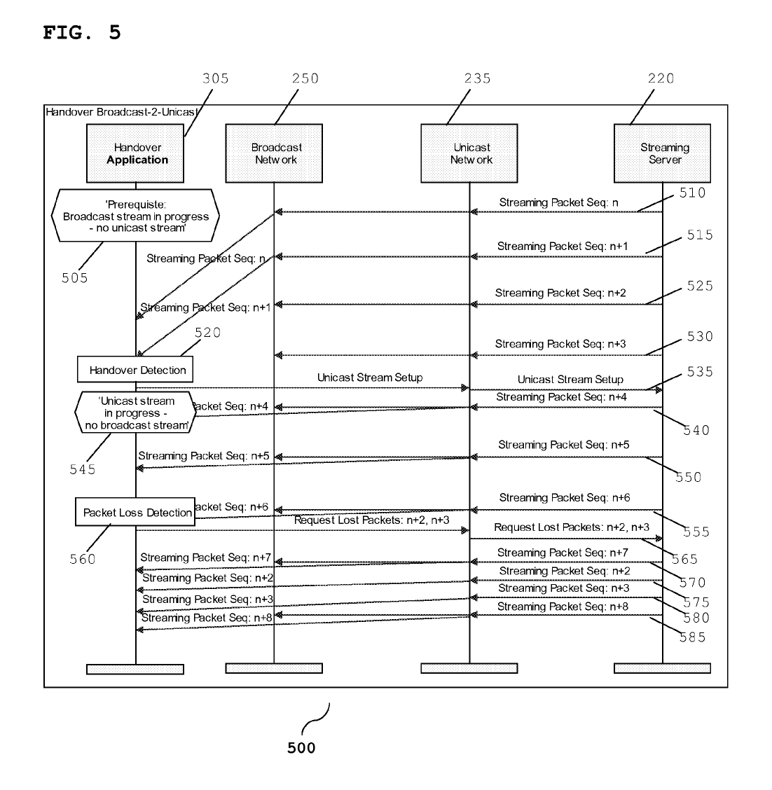

Referring now to FIG. 5, an example of a method 500 for handover of communication from a broadcast network 250 to a unicast network 235 is illustrated, in accordance with some embodiments of the invention. A streaming server 220 is streaming data packets to both a unicast network 235 and a broadcast network 250. The method starts with UE 114 receiving the streamed data packets via the broadcast network 250, as shown in step 505. Thus, UE 114 receives streaming packet sequence n, in step 510, followed by streaming packet sequence n+1′ in step 515. A handover application 230 of UE 114 detects that handover to a unicast deliver of the streamed data packets is to be performed in step 520. Whilst the unicast stream is being set up in step 535, the next streaming packet sequences n+2′ and n+3′ are temporarily lost to the UE 114, as shown in step 530, due to the delay introduced in the broadcast network 250 in delivering the data packet stream.

After the unicast stream has been set up in step 545, so that the UE 114 receives the data packet stream via the unicast network 235 instead of via the broadcast network 250, as shown in step 545, UE 114 receives streaming packet sequence n+5′ and n+6′ in step 550 and step 560. Recognising that streaming packet sequences n+2′ and n+3′ have been temporarily lost to the UE 114, i.e. the handover application 230 detects packet loss in step 560, the UE 114 requests a re-transmission of at least the lost packets from streaming server 220 in step 565. The UE 114 may also requests a transmission of additional packets in order to fill its buffering depth from streaming server 220 to compensate for any future loss of packets through further handover operations. The streaming server then streams packet sequence n+7′, followed by the lost packets n+2′ and n+3′ via the unicast network 235, as shown in steps 570, 575 and 580 respectively. The streaming process then returns to normal operation, with the streaming server 220 streaming packet sequence n+8′ to the UE 114 via the unicast network 235, as shown in step 585.

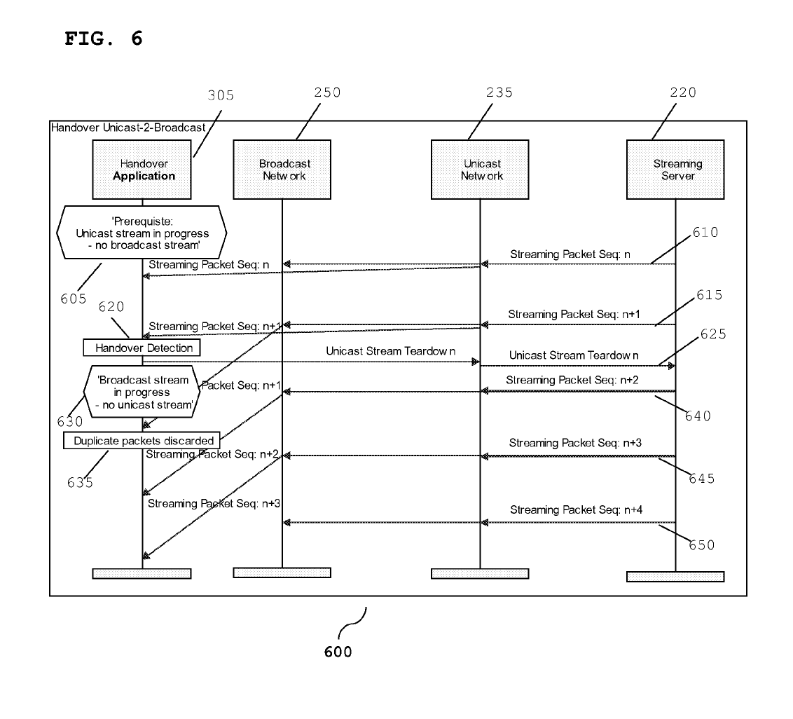

Referring now to FIG. 6 an example of a method 600 for handover of communication from a unicast network 235 to a broadcast network 250 is illustrated in accordance with some embodiments of the invention. A streaming server 220 is streaming data packets to both a unicast network 235 and a broadcast network 250. The method starts with UE 114 receiving the streamed data packets via the unicast network 235, as shown in step 605. Thus, UE 114 receives streaming packet sequence n, in step 610, followed by streaming packet sequence n+1′ in step 615. A handover application 230 of UE 114 detects that handover to a broadcast deliver of the streamed data packets is to be performed in step 620. Whilst the unicast stream is being torn down in step 625, the next streaming packet sequences n+2′ and n+3′ are being delayed by the broadcast network 250. Thus, by the time that handover from the unicast network 235 to the broadcast network 250 is complete, the broadcast network is streaming the next packet sequences desired by the UE 114, namely streaming packet sequence n+2′ and n+3′, as shown in step 640 and step 645. At some point, the handover application 230 (or some other logic or software program) of the UE 114 discards any duplicate data packets that it has received, as shown in step 635.

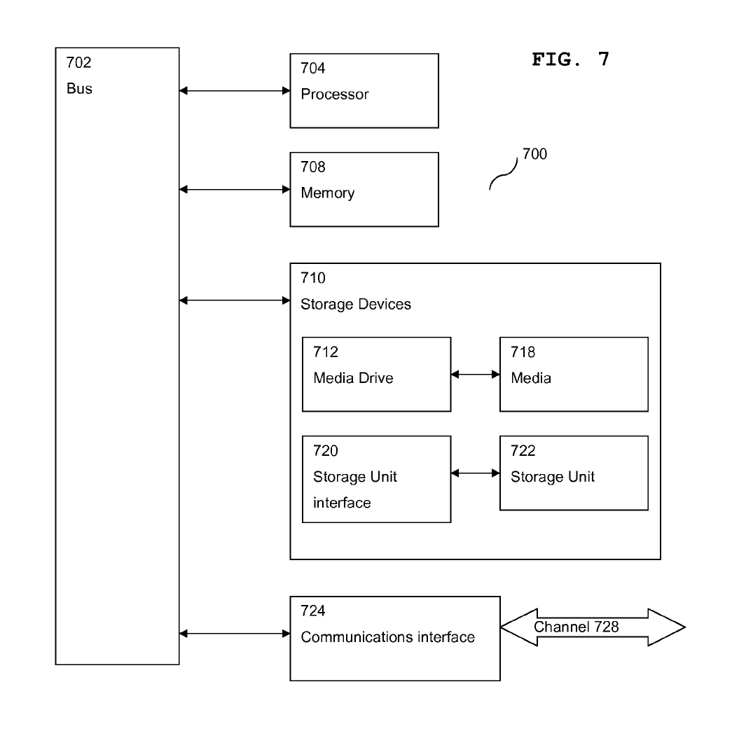

Referring now to FIG. 7, there is illustrated a typical computing system 700 that may be employed to implement signal processing functionality in embodiments of the invention. Computing systems of this type may be used in access points and wireless communication units. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special-purpose processing engine such as, for example, a microprocessor, microcontroller or other control logic. In this example, processor 704 is connected to a bus 702 or other communications medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having particular computer software or data stored therein.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, and optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms computer program product’ computer-readable medium’ and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, removable storage drive 722, drive 712 or communications interface 724. The control logic (in this example, software instructions or computer program code), when executed by the processor 704, causes the processor 704 to perform the functions of the invention as described herein.

It will be appreciated that, for clarity purposes, the above description has described embodiments of the invention with reference to different functional units and processors. However, it will be apparent that any suitable distribution of functionality between different functional units or processors, for example with respect to the broadcast mode logic or management logic, may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although one example embodiment of the invention describes a handover mechanism for use in a UTRA TDD system supporting both unicast network delivery and broadcast network delivery of the same data packet stream, it is envisaged that the inventive concept is not restricted to this example embodiment. In particular, for example, future evolutions of UMTS Terrestrial Radio Access (UTRA) 3GPP (currently referred to as long term evolution’ (LTE)) will also be able to benefit from the concepts described hereinbefore.

It is envisaged that the aforementioned inventive concept aims to provide one or more of the following advantages:
(i) The provision of the same broadcast packet stream supplied to both the broadcast network and unicast network, such that the streams on both are encoded at the same rate and the packets of the same number contain the same data, may avoid a necessity to flush buffers in a handover between broadcast and unicast and therefore minimize interruption to the video stream.
(ii) The provision of a time delay between the delivery of the same broadcast packet stream supplied to both the broadcast network and unicast network allows the first and subsequent received broadcast data packets to be used following handover from the unicast network.
(iii) The provision of buffering of data packets at the receiver allows a number of advanced data packets to be received via the unicast network for future use to compensate for any handover packet data loss.
(iv) The provision of additional packets to be received and buffered via a unicast delivery may be used as a fast start method for the broadcast channels alone.
(v) The removal of packet data loss through handover procedures provides an improved user perception of the streamed data.
(vi) A conservation in a battery life of the wireless communication unit can also be achieved through a reduction of signal processing for FEC.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second”, etc. do not preclude a plurality.

1.-22. (canceled)

23. A method of delivering data to a wireless communication unit in a communication system that comprises a broadcast network and a unicast network, the method comprising, at a network element:
encoding a data packet stream at a first rate for delivery over the broadcast network; encoding the same data packet stream at the first rate for delivery over the unicast network; and
concurrently transmitting the encoded data packet stream over the unicast network and broadcasting the encoded data packet stream over the broadcast network.

24. A network element for delivering data to a wireless communication unit in a communication system that comprises a broadcast network and a unicast network, the network element comprising:
at least one encoder arranged to encode a data packet stream at a first rate for delivery over the broadcast network and encode the same data packet stream at the first rate for delivery over the unicast network; and
a transmitter arranged to concurrently transmit the encoded data packet stream over both the unicast network and the broadcast network.

25. A wireless communication unit for performing handover in a communication system that comprises a broadcast network and a unicast network, the wireless communication unit comprising:
a receiver arranged to receive a data packet stream at a first rate delivered over a first network;
a decoder arranged to decode the received data packet stream;
a signal processor arranged to perform a handover from the first network to a second network, wherein following handover, the decoder is arranged to decode the same data packet stream at the first rate over the second network; and
wherein the first network and the second network operate different delivery mechanisms and each comprise one of: a unicast network and a broadcast network.
